(19) United States
(12) Patent Application Publication
(10) Pub. No.: US 2006/0126643 A1
(43) Pub. Date: Jun. 15, 2006

(54) Subscriber loop remote control apparatus, subscriber loop remote control method, and subscriber loop remote control program

(75) Inventors: Sou Satou, Tokyo (JP); Toshihiko Kusano, Tokyo (JP)

Correspondence Address: SUGHRUE MION, PLLC, 2100 PENNSYLVANIA AVENUE, N.W., SUITE 800, WASHINGTON, DC, 20037, US

(73) Assignee: NEC CORPORATION

(21) Appl. No.: 11/296,344

(22) Filed: Dec. 8, 2005

(30) Foreign Application Priority Data
Dec. 9, 2004 (JP) 357424 / 2004
Dec. 7, 2005 (JP) 353059 / 2005

(51) Int. Cl. H04L 12/28

(52) U.S. Cl. 370/395.53

(57) ABSTRACT

A subscriber loop remote control apparatus that allows communication terminals to transmit VLAN packets without imposing a load on a router. A subscriber loop remote control apparatus is provided with a virtual interface table for associating a subscriber premises terminal identifier individually assigned to a subscriber premises terminal connected through a communication cable to a port assigned to every packet of each group which constitutes a VLAN with the port number of the port to store and manage them. When receiving a packet, the subscriber loop remote control apparatus determines whether or not a subscriber premises terminal identifier contained in the packet matches any of those in the virtual interface table. When the subscriber premises terminal identifier matches one of those in the virtual interface table, the subscriber loop remote control apparatus returns and transmits the packet to the destination before the router side.

### BACKGROUND OF THE INVENTION

The present invention relates to a subscriber loop remote control apparatus, a subscriber loop remote control method, and a subscriber loop remote control program capable of performing various processing, such as filtering, to a packet transmitted through a prescribed path. More particularly, the present invention relates to a subscriber loop remote control apparatus, a subscriber loop remote control method, and a subscriber loop remote control program capable of performing various processing, such as filtering, to a packet transmitted through a path connected to each subscriber premises terminal which is closest to each communication terminal on the uplink side.

### DESCRIPTION OF RELATED ART

With the widespread use of LANs (Local Area Networks), various types of communication terminals are commonly connected to networks. In the case of a LAN using Ethernet®, packets are transmitted to communication terminals connected to the LAN cable, respectively, and a communication terminal corresponding to the destination of a packet receives the packet. Consequently, there is a possibility that a malicious third party may receive a packet addressed to another person, resulting in a security problem.

For example, in Japanese Patent Laid-Open No. HEI 11-331237 (chapter 0010, FIG. 1), there is disclosed a conventional technology to improve security. According to the conventional technology, a communication network is divided into a plurality of groups by VLANs (Virtual Local Area Networks), and a packet is transmitted only to a grouped network.

In addition, a technology has been proposed in which communication is restricted to be performed from one specific point to another specific point through a PPP (Point-to-Point Protocol) session. Hereafter, a description will be given of the conventional communication technology using a PPP session referring to FIG. 1. FIG. 1 is a diagram showing the system configuration of a conventional communication network using a PPP session.

As shown in FIG. 1, a packet communication system 100 for the conventional communication network using a PPP session includes a packet communication network 101 which performs packet communication based on Ethernet®.

The packet communication network 101 is connected to the 0th port P₀ of a switch 103 through an access server (BAS: Broadband Access Server) 102. The switch 103 is provided with first to k-th ports P₁ to Pₖ for connection with optical fibers, respectively. Incidentally, the reference character k indicates an integer equal to or larger than “5”. Among these, the first and second ports P₁ and P₂ are connected to the uplink side of an OLT (Optical Line Terminal) 104.

The downlink side of the OLT 104 is connected to one optical fiber 106₁ correspondingly to the first port P₁, which constitutes part of an optical network called first EPON (Ethernet Passive Optical Network) 105¹. The optical fiber 106¹ is connected to a splitter 107₁ as a branch unit. The downlink side of the splitter 107₁ is connected to m optical fibers 108₁₁ to 108₁ₘ. Incidentally, the reference character m indicates an integer equal to or larger than “2”. The m optical fibers 108₁₁ to 108₁ₘ are connected to ONUs (Optical Network Units: subscriber premises terminals) 109₁₁ to 109₁ₘ, respectively. The downlink sides of the ONUs 109₁₁ to 109₁ₘ are connected to communication terminals 110₁₁ to 110₁ₘ, such as personal computers. While one communication terminal 110 is connected to one ONU 109 in FIG. 1, a plurality of communication terminals 110 may be connected to one ONU 109.

In addition, the downlink side of the OLT 104 is connected to the second EPON (Ethernet Passive Optical Network) 105₂ correspondingly to the second port P₂. The second EPON 105₂ is substantially the same as the first EPON 105₁. Besides, ONUs 109₂₁ to 109₂ₘ and communication terminals 110₂₁ to 110₂ₘ have substantially the same connection relation as that between the ONUs 109₁₁ to 109₁ₘ and the communication terminals 110₁₁ to 110₁ₘ. Accordingly, like reference characters refer to corresponding portions which constitutes the first and second EPONs 105₁ and 105₂, and the same description will not be repeated. However, in order to differentiate between units or parts of the first and second EPONs 105₁ and 105₂, each unit or part of the first EPON 105₁ is denoted by a reference numeral with a subscript the tens digit of which is “1”, while that of the second EPON 105₂ is denoted by a reference numeral with a subscript the tens digit of which is “2”.

The third port P₃ of the switch 103 is connected to an end of a switch 123 through a first multimedia converter (M/C) 121₁ and a second multimedia converter (M/C) 122₁ which perform mutual media data conversion and the like. The switch contact side of the switch 123 is connected to communication terminals 124₁ to 124ⱼ, such as personal computers. Incidentally, the reference character j indicates an integer equal to or larger than “2”. The switch 123 is a layer 2 switch.

The fourth port P₄ of the switch 103 is connected to a communication terminal 126₁, such as a personal computer, through a first multimedia converter (M/C) 121₂ and a second multimedia converter (M/C) 122₂. Similarly, each of the ports P, from fifth port P₅ to k-th port Pₖ, of the switch 103 is connected in one to one correspondence with a communication terminal 126, such as a personal computer, through a first multimedia converter (M/C) 121 and a second multimedia converter (M/C) 122.

In the packet communication system shown in FIG. 1, the access server 102 and the respective communication terminals 110₁₁ to 110₁ₘ, 110₂₁ to 110₂ₘ, 124₁ to 124ⱼ, and 126₁ to 126ₖ₋₃ are connected via PPPoE (PPP over Ethernet®) as indicated by arrows 131. Since the PPPoE connection is a Point-to-Point connection, data are transmitted in unicast frames between them. Thereby, the respective communication terminals 110₁₁ to 110₁ₘ, 110₂₁ to 110₂ₘ, 124₁ to 124ⱼ, and 126₁ to 126ₖ₋₃ are associated in one to one correspondence with the access server 102. That is, even if the EPONs 105₁ and 105₂ exist between the respective communication terminals 110₁₁ to 110₁ₘ, 110₂₁ to 110₂ₘ, 124₁ to 124ⱼ and 126₁ to 126ₖ₋₃, and the access server 102, the access server 102 can identify the respective communication terminals 110₁₁ to 110₁ₘ, 110₂₁ to 110₂ₘ, 124₁ to 124ⱼ, and 126₁ to 126ₖ₋₃.

The packet communication system 100 shown in FIG. 1, however, has a problem of the load to maintain a PPP session. In addition, in order to achieve data transmission with a point-to-point connection, all data need to be transmitted through the access server 102. Furthermore, since a PPP session requires a user name (and password), it is necessary to have accounts in the access server 102 as well as the respective communication terminals 110₁₁ to 110₁ₘ, 110₂₁ to 110₂ₘ, 124₁ to 124ⱼ, and 126₁ to 126ₖ₋₃. As a result, a communication system becomes complicated.

As such, IPoE (Internet Protocol over Ethernet®) connection may be used as in a network using DHCP (Dynamic Host Configuration Protocol) without performing such a PPP session. In this case, however, the OLT 104 and switch 123 intervene between the switch 103 and respective communication terminals 110₁₁ to 110₁ₘ, 110₂₁ to 110₂ₘ, 124₁ to 124ⱼ, and 126₁ to 126ₖ₋₃ as shown in FIG. 1, and the switch 103 side cannot identify the subscriber side. In order to solve this problem, the subscriber side may be identified by VLAN (Virtual Local Area Network) Tagging.

However, the VLAN tagging is originally intended to identify the area that a broadcast frame can reach. That is, a VLAN tag is not suitable for use as the identification number of a port. As a result of VLAN tagging, all the communication terminals 110₁₁ to 110ₘ, 110₂₁ to 110₂ₘ, 124₁ to 124ⱼ, and 126₁ to 126ₖ₋₃ connected to the switch 103 in a packet communication system shown in FIG. 2 are recognized as those belonging to different VLANs, respectively. Consequently, all packets transmitted in the uplink direction from the communication terminals 110₁₁ to 110₁ₘ, 110₂₁ to 110₂ₘ, 124₁ to 124ⱼ, and 126₁ to 126ₖ₋₃ are recognized as different VLAN packets. Hence, all traffic are transmitted with different VLAN numbers uniformly to the router 102 arranged in the uplink side of the switch 103, and the communication terminals 110₁₁ to 110₁ₘ, 110₂₁ to 110₂ₘ, 124₁ to 124ⱼ, 126₁ to 126ₖ₋₃ communicate through the router 102 that stores the VLAN numbers of respective terminals 110₁₁ to 110₁ₘ, 110₂₁ to 110₂ₘ, 124₁ to 124ⱼ, and 126₁ to 126ₖ₋₃. That is, similarly to the access server 102 shown in FIG. 1, even when communication is performed within and between the communication terminals, packets have to be returned by the router 102, which causes loads to concentrate on the router 102. In addition, useless traffic is generated in the path to the router 102.

### SUMMARY OF THE INVENTION

It is therefore an object of the present invention to provide a subscriber loop remote control apparatus, a subscriber loop remote control method, and a subscriber loop remote control program which allow communication terminals to transmit VLAN packets without imposing a load on a router.

In accordance with an aspect of the present invention, to achieve the object mentioned above, there is provided a subscriber loop remote control apparatus comprising: (a) an association table for associating a subscriber premises terminal identifier individually assigned to a subscriber premises terminal connected through a communication cable to a port assigned to every packet of each group which constitutes a VLAN (Virtual Local Area Network) with the port number of the port to store and manage them; (b) a packet receiver for receiving a VLAN packet with a subscriber premises terminal identifier and a port number; (c) an association table checker for checking the association table based on the port number and the subscriber premises terminal identifier attached to the VLAN packet received by the packet receiver, and determining whether or not the subscriber premises terminal identifier attached to the VLAN packet matches any of those in the association table; and (d) a packet return unit for returning, when the association table checker has determined that the subscriber premises terminal identifier attached to the VLAN packet matches one of those in the association table, the VLAN packet to the subscriber premises terminal with the subscriber premises terminal identifier.

Namely, in the subscriber loop remote control apparatus of the present invention, when a port is assigned to a VLAN, a port, a subscriber premises terminal identifier assigned to a subscriber premises terminal connected through a communication cable to the port and the port number of the port are associated with each other, and information on them is stored and managed in an association table. When receiving a VLAN packet with a subscriber premises terminal identifier and a port number from a subscriber premises terminal side, the subscriber loop remote control apparatus checks the association table based on the subscriber premises terminal identifier and port number attached to the received VLAN packet, and determines whether or not the subscriber premises terminal identifier attached to the VLAN packet matches any of those in the association table. If having determined that the subscriber premises terminal identifier matches one of those in the association table, the subscriber loop remote control apparatus returns the VLAN packet to the subscriber premises terminal side with the subscriber premises terminal identifier.

In accordance with another aspect of the present invention, there is provided a subscriber loop remote control method and a program implementing the method for a subscriber loop remote control apparatus including an association table for associating a subscriber premises terminal identifier individually assigned to a subscriber premises terminal connected through a communication cable to a port assigned to every packet of each group which constitutes a VLAN (Virtual Local Area Network), a subscriber premises terminal identifier individually assigned to a subscriber premises terminal connected through a communication cable to the port and the port number of the port;. The subscriber loop remote control method comprises the steps of (e) receiving a VLAN packet with a subscriber premises terminal identifier and a port number; (f) checking the association table based on the port number and the subscriber premises terminal identifier attached to the received VLAN packet, and determining whether or not the subscriber premises terminal identifier attached to the VLAN packet matches any of those in the association table; and (g) returning, when the subscriber premises terminal identifier attached to the VLAN packet matches one of those in the association table, the VLAN packet to the subscriber premises terminal with the subscriber premises terminal identifier.

That is, a VLAN packet is transmitted in the uplink direction from the subscriber loop remote control apparatus, which eliminates the necessity to input the VLAN packet to a router. Thus, it is possible to reduce a load on the router.

Besides, in the subscriber loop remote control apparatus, subscriber loop remote control method and subscriber loop remote control program according to the present invention, a subscriber premises terminal identifier individually assigned to each subscriber premises terminal is attached to a VLAN packet. Thereby, in one VLAN, a packet path can be analyzed and various processing, such as filtering, can be performed with respect to each path. In addition, since a subscriber premises terminal identifier is attached to a packet, when the identifier is not necessary, the identifier may be removed.

As just described, in accordance with the present invention, a VLAN packet is transmitted in the uplink direction from the subscriber loop remote control apparatus, which eliminates the necessity to input the VLAN packet to a router. Thus, it is possible to reduce a load on the router.

### BRIEF DESCRIPTION OF THE DRAWINGS

The exemplary aspects and features of the present invention will become more apparent from the consideration of the following detailed description taken in conjunction with the accompanying drawings in which:

FIG. 1 is a diagram showing the system configuration of a conventional communication network using a PPP session;

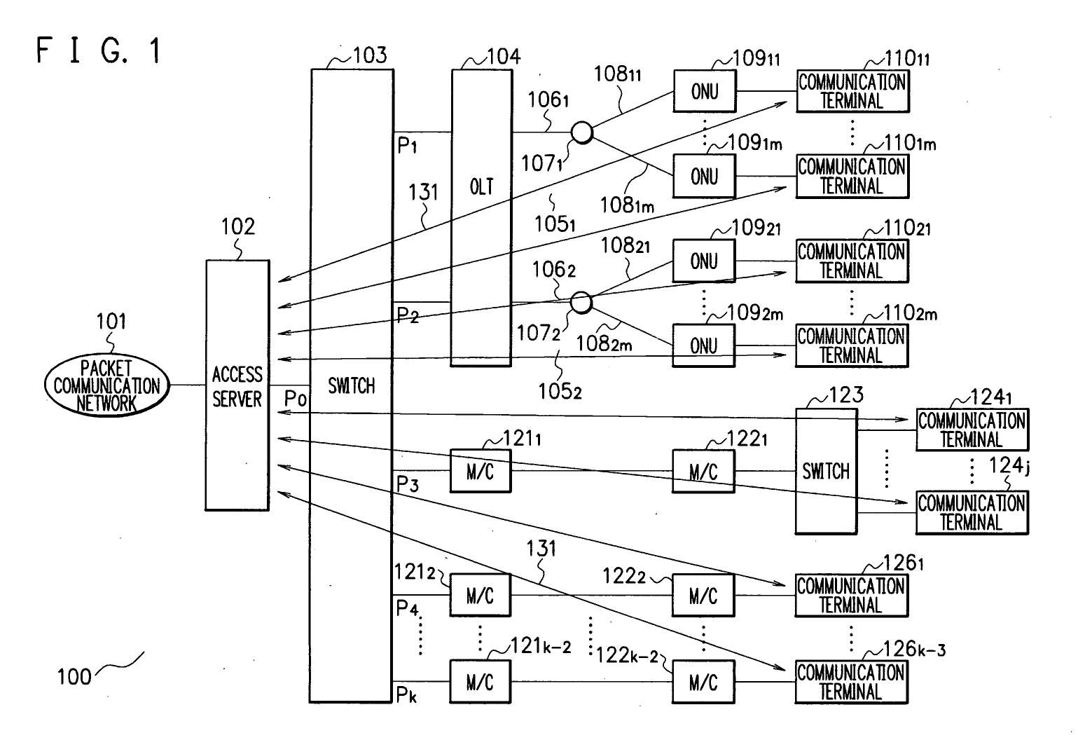

FIG. 2 is a diagram showing the system configuration of a communication network using a VLAN (Virtual Local Area Network) Tagging;

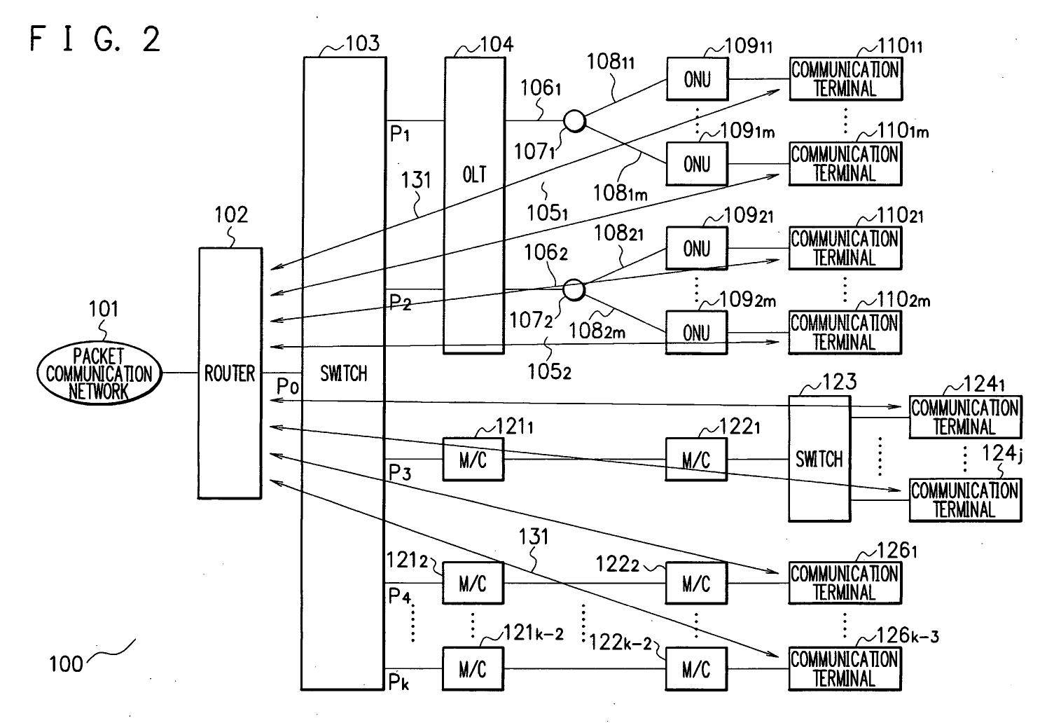

FIG. 3 is a diagram showing the configuration of a packet communication system according to an embodiment of the present invention;

FIG. 4 is a block diagram showing the configuration of a subscriber loop remote control apparatus of this embodiment;

FIG. 5 is a block diagram showing the configuration of a bridge forwarder, a filter, and a virtual interface converter corresponding to a first interface circuit of the embodiment;

FIG. 6 is a block diagram showing the configuration of a bridge forwarder, a filter, and a virtual interface converter corresponding to a second interface circuit of the embodiment;

FIG. 7 is a block diagram showing the configuration of a bridge forwarder, a filter, and a virtual interface converter corresponding to a third interface circuit of the embodiment;

FIG. 8 is a block diagram showing the configuration of a bridge forwarder, a filter, and a virtual interface converter corresponding to fourth to k-th ports P₄ to Pₖ of the embodiment;

FIG. 9 is a diagram showing the configuration of a virtual interface table of the embodiment;

FIG. 10 is a flowchart showing the control operation of a virtual interface converter for transmitting a packet in the uplink direction; and

FIG. 11 is a flowchart showing the control operation of the virtual interface converter for transmitting a packet in the downlink direction.

### DESCRIPTION OF THE PREFERRED EMBODIMENT

Referring now to the drawings, a description of a preferred embodiment of the present invention will be given in detail.

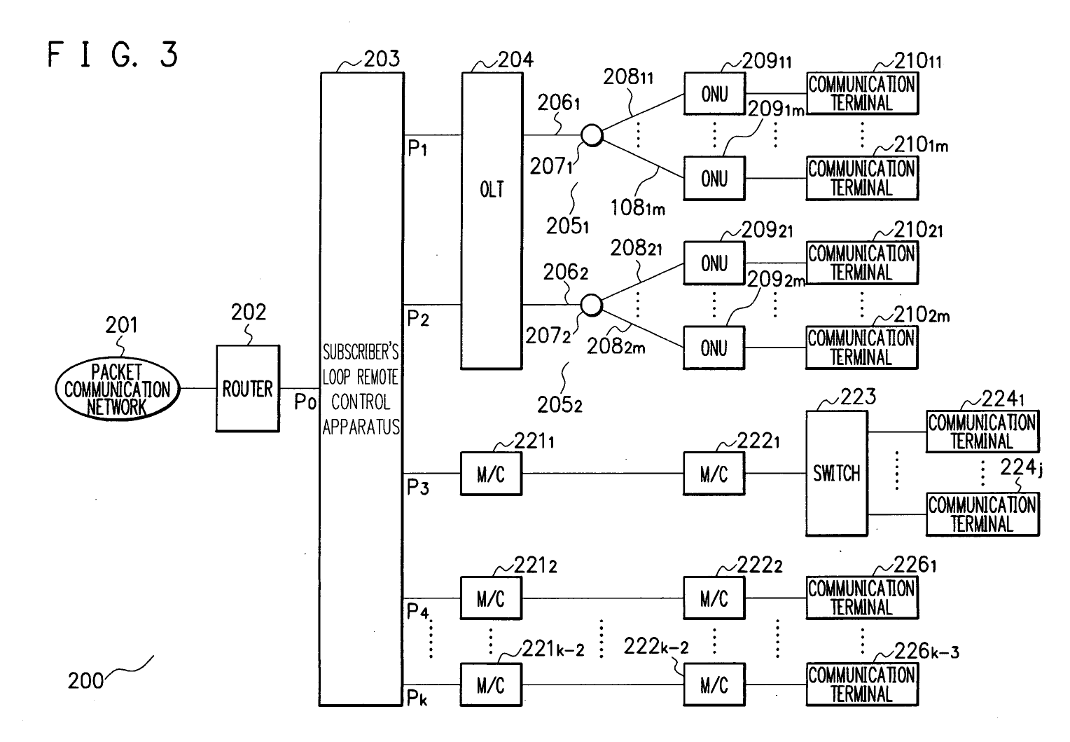

FIG. 3 is a diagram schematically showing the configuration of a packet communication system including a subscriber loop remote control apparatus according to an embodiment of the present invention.

The subscriber loop remote control apparatus 203 of this embodiment comprises: an association table for associating a subscriber premises terminal identifier individually assigned to each of subscriber premises terminals (ONUs 209₁₁ to 209₁ₘ, 209₂₁ to 209₂ₘ, and communication terminals 224₁ to 224ⱼ, and 226₁ to 226ₖ₋₃) connected through communication cables to each of ports (P₁ to Pₖ) assigned to respective packets of each group which constitutes a VLAN (Virtual Local Area Network) with the port number of each of the ports (P₁ to Pₖ) to store and manage them; a packet receiver for receiving a VLAN packet with a subscriber premises terminal identifier and a port number; an association table checker for checking the association table based on the port number and the subscriber premises terminal identifier attached to the VLAN packet received by the packet receiver, and determining whether or not the subscriber premises terminal identifier attached to the VLAN packet matches any of those in the association table; and a packet return unit for returning, when the association table checker has determined that the subscriber premises terminal identifier attached to the VLAN packet matches one of those in the association table, the VLAN packet to the subscriber premises terminal with the subscriber premises terminal identifier. That is, a VLAN packet is transmitted in the uplink direction from the subscriber loop remote control apparatus 203, which eliminates the necessity to input the VLAN packet to a router 202. Thus, it is possible to reduce a load on the router 202.

### First Embodiment

First, the configuration of a packet communication system including the subscriber loop remote control apparatus according to an embodiment of the present invention will be described referring to FIG. 3. Incidentally, a packet communication system 200 includes a packet communication network 201 for performing packet communication based on Ethernet®.

The packet communication network 201 of this embodiment is connected to the 0th port P₀ of the subscriber loop remote control apparatus 203 through the router 202 for achieving data exchange between networks. The subscriber loop remote control apparatus 203 is provided with first to k-th ports P₁ to Pₖ for connection with optical fibers, respectively. Incidentally, the reference character k indicates an integer equal to or larger than “5”. Among these, the first and second ports P₁ and P₂ are connected to the uplink side of an OLT (Optical Line Terminal) 204.

The downlink side of the OLT 204 is connected to one optical fiber 206₁ correspondingly to the first port P₁, which constitutes part of an optical network called first EPON (Ethernet Passive Optical Network) 205₁. The optical fiber 206₁ is connected to a splitter 207₁ as a branch unit. The downlink side of the splitter 207₁ is connected to m optical fibers 208₁₁ to 208₁ₘ. Incidentally, the reference character m indicates an integer equal to or larger than “2”. The m optical fibers 208₁₁ to 208₁ₘ are connected to ONUs (Optical Network Units: subscriber premises terminals) 209₁₁ to 209₁ₘ, respectively. The downlink sides of the ONUs 209₁₁ to 209₁ₘ are connected to communication terminals 210₁₁ to 210₁ₘ, such as personal computers. While one communication terminal 210 is connected to one ONU 209 in FIG. 3, a plurality of communication terminals 210 may be connected to one ONU 209.

In addition, the downlink side of the OLT 204 is connected to the second EPON 205₂ correspondingly to the second port P₂. The second EPON 205₂ is substantially the same as the first EPON 205₁. Accordingly, like reference characters refer to corresponding portions which constitutes the first and second EPONs 205₁ and 205₂, and the same description will not be repeated. However, in order to differentiate between units or parts of the first and second EPONs 205₁ and 205₂, each unit or part of the first EPON 205₁ is denoted by a reference numeral with a subscript the tens digit of which is “1”, while that of the second EPON 205₂ is denoted by a reference numeral with a subscript the tens digit of which is “2”.

The third port P₃ of the subscriber loop remote control apparatus 203 is connected to an end of a switch 223 through a first multimedia converter (M/C) 221₁ and a second multimedia converter (M/C) 222₁ which perform mutual media data conversion and the like. The switch contact side of the switch 223 is connected to communication terminals 224₁ to 224ⱼ, such as personal computers. Incidentally, the reference character j indicates an integer equal to or larger than “2”. The switch 223 is a layer 2 switch. In this embodiment, a switch which is relatively inexpensive or has a simple configuration is used as the switch 223, and communication between respective communication terminals 224₁ to 224ⱼ is enabled without requiring the router 202 for higher performance. This point will be more fully described hereinafter.

The fourth port P₄ of the subscriber loop remote control apparatus 203 is connected to a communication terminal 226₁, such as a personal computer, through a first multimedia converter (M/C) 221₂ and a second multimedia converter (M/C) 222₂. Similarly, each of the ports P, from fifth to k-th ports, of the subscriber loop remote control apparatus 203 is connected in one to one correspondence with a communication terminal 226, such as a personal computer, through a first multimedia converter 221 and a second multimedia converter 222. Incidentally, the first multimedia converter 221₁ and second multimedia converter 221₁ corresponding to the third port P₃ may be removed so that Ethernet® frames can be directly transmitted between the third port P₃ and respective communication terminals 224₁ to 224ⱼ.

In the packet communication system of FIG. 3, each packet from the communication terminals 210₁₁ to 210₁ₘ, 210₂₁ to 210₂ₘ, or 224₁ to 224ⱼ is attached with a VLAN tag to identify the source at the ONUs 209₁₁ to 209₁ₘ and 209₂₁ to 209₂ₘ, or the switch 223 with respect to respective ports connected to the communication terminals 224₁ to 224ⱼ, closest to the terminals 210₁₁ to 210₁ₘ, 210₂₁ to 210₂ₘ and 224₁ to 224ⱼ in the uplink side, and transmitted in the uplink direction.

Thereby, the subscriber loop remote control apparatus 203 can individually identify the communication terminals 210₁₁ to 210₁ₘ connected to the port P₁, the communication terminals 210₂₁ to 210₂ₘ connected to the port P₂, and the communication terminals 224₁ to 224ⱼ connected to the port P₃.

Besides, the subscriber loop remote control apparatus 203 attaches a VLAN tag to a packet transmitted in the downlink direction so that the ONUs 209₁₁ to 209₁ₘ and 209₂₁ to 209₂ₘ, or the switch 223 can be individually identified.

The fourth to k-th ports P₄ to Pₖ of the subscriber loop remote control apparatus 203 are connected in one to one correspondence with the communication terminals 226₁ to 226ₖ₋₃ through optical fibers. Hence, with respect to the fourth to k-th ports P₄ to Pₖ, a VLAN tag is not required.

The VLAN tagging mentioned above is similar in terminology to the VLAN tag used in this embodiment. However, the VLAN tagging is to add tag information (tag/header) indicating the group number of a VLAN to a basic MAC frame to identify each VLAN. The VLAN tag used in this embodiment is different from the VLAN tagging in that the ONUs 209₁₁ to 209₁ₘ and 209₂₁ to 209₂ₘ, or the switch 223 closest to respective communication terminals 210₁₁ to 210₁ₘ, 210₂₁ to 210₂ₘ, and 224₁-224ⱼ can be identified. For example, when a plurality of ONUs 209 constitutes a VLAN, the respective ONUs 209 cannot be identified by the VLAN tagging, but can be identified by the VLAN tag used in this embodiment.

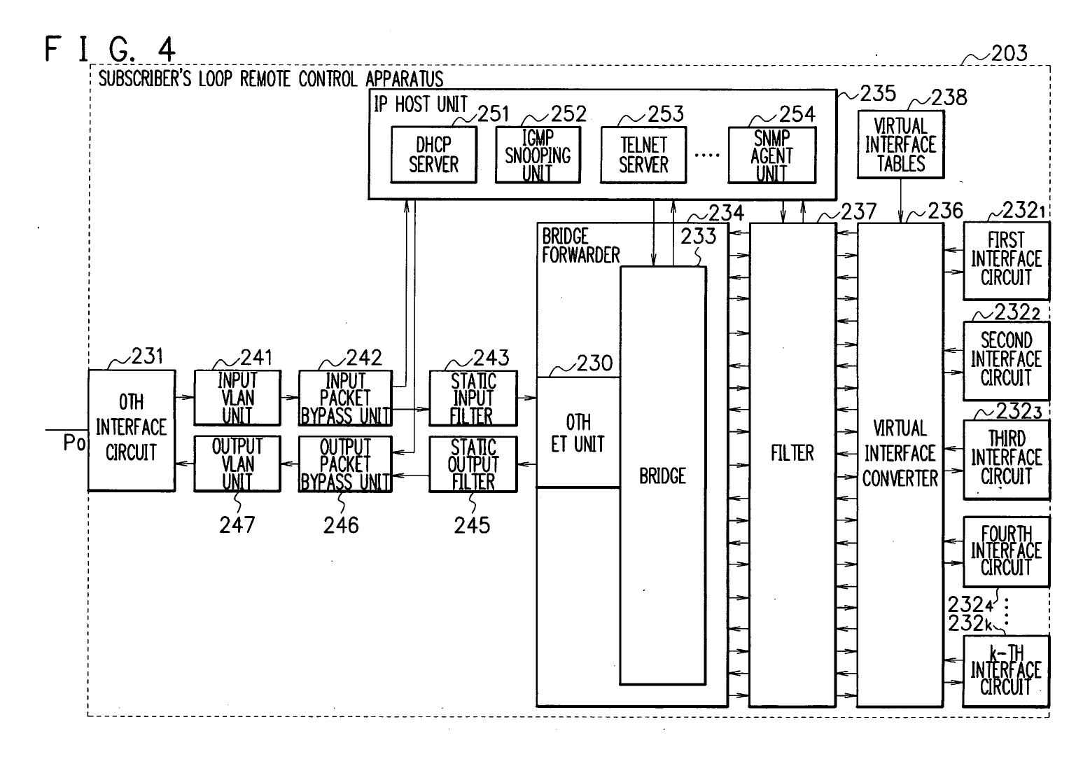

Next, the internal configuration of the subscriber loop remote control apparatus 203 shown in FIG. 3 will be described referring to FIG. 4. FIG. 4 shows the configuration of the principal part of the subscriber loop remote control apparatus 203 shown in FIG. 3.

As shown in FIG. 4, the subscriber loop remote control apparatus 203 comprises a 0th interface circuit 231 connected to the 0th port P₀, and first to k-th interface circuits 232₁ to 232ₖ corresponding to the first to k-th ports, respectively, as interface circuits having one to one correspondence to the respective ports. In addition, the subscriber loop remote control apparatus 203 further comprises a bridge forwarder 234, an IP (Internet Protocol) host unit 235, a virtual interface converter 236, a filter 237, and a virtual interface table 238 as main constituents.

The bridge forwarder 234 includes a built-in bridge 233, performs layer 2 transmission, and classifies a packet based on a MAC Address (Media Access Control Address). The IP host unit 235 performs various controls inside the subscriber loop remote control apparatus 203. The virtual interface converter 236 is connected to the first to k-th interface circuits 232₁ to 232ₖ. The filter 237 is arranged between the bridge forwarder 234 and virtual interface converter 236. Besides, the virtual interface converter 236 is connected to the virtual interface table 238.

Further, the 0th interface circuit 231 connected to the 0th port P₀, and a 0th Ethernet® (ET) unit 230 of the bridge forwarder 234a are connected by first and second paths. The first path reaches the 0th Ethernet® (ET) unit 230 from the 0th interface circuit 231 through an input VLAN (Virtual Local Area Network) unit 241, an input packet bypass unit 242, and a static input filter 243. The second path reaches the 0th interface circuit 231 from the 0th ET unit 230 through a static output filter 245, an output packet bypass unit 246, and an output VLAN unit 247.

The output of the input packet bypass unit 242 is sent to the static input filter 243 or IP host unit 235. That is, while an IGMP (Internet Group Management) message packet and a DHCP (Dynamic Host Configuration Protocol) message packet are sent to the IP host unit 235, packets other than them are input to the static input filter 243.

Among these, the IGMP message packet input to the IP host unit 235 is input to an IGMP snooping unit 252 to be processed. The DHCP message packet is input to a DHCP server 251 to be processed. The output of the IP host unit 235 is input to the output packet bypass unit 246. In addition, packets whose destination is the subscriber loop remote control apparatus 203 itself are input and output between the bridge 233 and IP host unit 235 with the exception of the IGMP message packet and DHCP message packet as mentioned above. 20 The IP host unit 235 includes the DHCP server 251 as a server for providing the DHCP service, the IGMP snooping unit 252 for performing IGMP snooping, a Telnet server 253 for connecting to a computer connected to a network in a remote place, an SNMP (Simple Network Management Protocol) agent unit 254, and the like. Here, IGMP is a protocol for a router to check whether or not there is a host on a subnet which joins multicast.

Namely, the IGMP snooping unit 252 determines the receiver of multicast traffic and registers it in a MAC (Media Access Control) address table (not shown) to constrain the flooding of multicast traffic at the switch control.

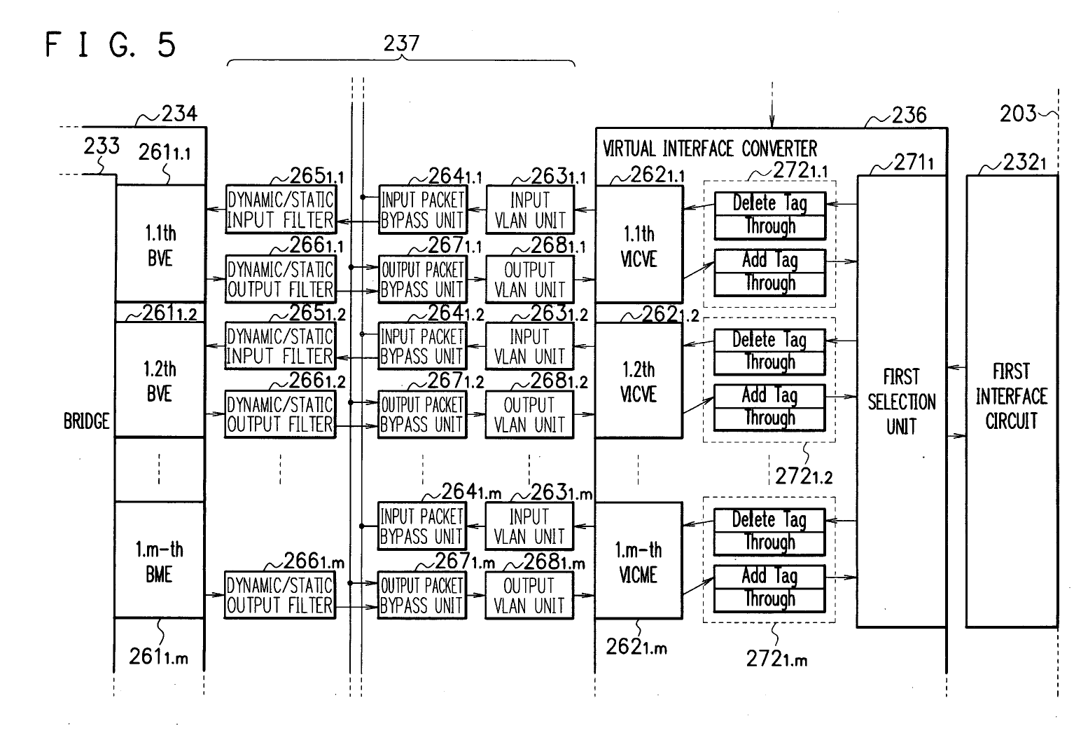

Next, referring to FIG. 5, a description will be given of the configuration of the bridge forwarder 234, filter 237, and virtual interface converter 236 corresponding to the first interface circuit 232₁ shown in FIG. 4. FIG. 5 shows the configuration of the bridge forwarder 234, filter 237, and virtual interface converter 236 corresponding to the first interface circuit 232₁ shown in FIG. 4. The circuit shown in FIG. 5 corresponds to the first EPON 205₁ shown in FIG. 3.

As shown in FIG. 5, correspondingly to the ONUs 209₁₁ to 209₁ₘ shown in FIG. 3, the bridge 233a is provided with Ethernet® units from a 1.1th bridge side virtual Ethernet® unit (1.1th BVE) 261_{1.1} to a 1.m-th bridge side multicast Ethernet® unit (1.m-th BME) 261_{1.m}. In addition, correspondingly to the ONUs 209₁₁ to 209₁ₘ shown in FIG. 3, the virtual interface converter 236 is provided with Ethernet® units from a 1.1th virtual interface converter side virtual Ethernet® unit (1.1th VICVE) 262_{1.1} to a 1.m-th virtual interface converter side multicast Ethernet® unit (1.m-th VICME) 262_{1.m}.

Between the 1.1th bridge side virtual Ethernet® unit (1.1th BVE) 261_{1.1} and a 1.1th virtual interface converter side virtual Ethernet® unit (1.1th VICVE) 262_{1.1}, an input VLAN unit 263_{1.1}, an input packet bypass unit 264_{1.1}, and a dynamic/static input filter 265_{1.1} are arranged in series in this order in the uplink direction. In addition, a static/dynamic output filter 266_{1.1}, an output packet bypass unit 267_{1.1}, and an output VLAN unit 268_{1.1} are arranged in series in this order in the downlink direction.

Here, the input VLAN unit 263_{1.1} is an input circuit of the VLAN. The input packet bypass unit 264_{1.1} sends an input packet either to the IP host unit 235 or to the dynamic/static input filter 265_{1.1} the dynamic/static input filter 265_{1.1} is an input filter consisting of a dynamic filter and a static filter. The static/dynamic output filter 266_{1.1th}e is an output filter consisting of a dynamic filter and a static filter. The output packet bypass unit 267_{1.1} is a circuit which receives a packet from two directions: the IP host unit 235 and static/dynamic output filter 266_{1.1th}e output VLAN unit 268_{1.1} is an output circuit of the VLAN.

Similarly, between the 1.2th bridge side virtual Ethernet® unit (1.2th BVE) 261_{1.2} and the 1.2th virtual interface converter side virtual Ethernet® unit (1.2th VICVE) 262_{1.2}, an input VLAN unit 263_{1.2}, an input packet bypass unit 264_{1.2}, and a dynamic/static input filter 265_{1.2} are arranged in series in this order in the uplink direction. In addition, a static/dynamic output filter 266_{1.2}, an output packet bypass unit 267_{1.2}, and an output VLAN unit 268_{1.2} are arranged in series in this order in the downlink direction. The others are arranged in the same manner as above.

Incidentally, a packet output from the 1.m-th bridge side multicast Ethernet® unit (1.m-th BME) 261_{1.m} is input to the 1.m-th virtual interface converter side multicast Ethernet® unit (1.m-th VICME) 262_{1.m} through a static output filter 266_{1.m}, an output packet bypass unit 267_{1.m} and an output VLAN unit 268_{1.m}.

The virtual interface converter 236 further includes a first selection unit 271₁ which exchanges data with the first interface circuit 232₁. The first selection unit 271₁ selects packets to the Ethernet® units from the 1.1th virtual interface converter side virtual Ethernet® unit (1.1th VICVE) 262_{1.1} to the 1.m-th virtual interface converter side multicast Ethernet® unit (1.m-th VICME) 262_{1.m} in the uplink direction, and collects packets in the first interface circuit 232₁ in the downlink direction. Incidentally, the first selection unit 271₁, which functions as a virtual interface circuit for selection in the uplink direction, makes a selection using the virtual interface table 238 shown in FIG. 4. This will be described later.

Further, between the first selection unit 271₁ and the Ethernet® units from the 1.1th virtual interface converter side virtual Ethernet® unit (1.1th VICVE) 262_{1.1} to the 1.m-th virtual interface converter side multicast Ethernet® unit (1.m-th VICME) 262_{1.m}, tag processing units 272_{1.1} to 272_{1.m} are provided correspondingly to the virtual Ethernet® or multicast Ethernet®. These tag processing units 272_{1.1} to 272_{1.m} perform Delete Tag or Through processing in the uplink direction, and perform Add Tag or Through processing in the downlink direction, which will also be specifically described later.

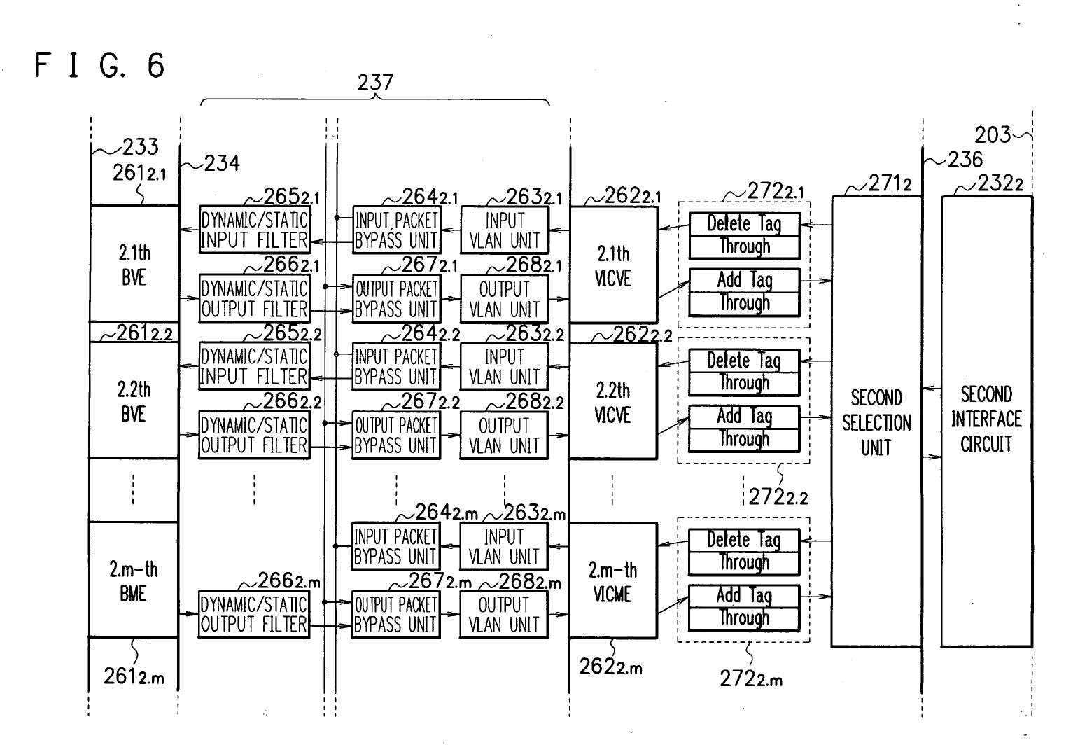

Next, referring to FIG. 6, a description will be given of the configuration of the bridge forwarder 234, filter 237, and virtual interface converter 236 corresponding to the second interface circuit 232₂ shown in FIG. 4. FIG. 6 shows the configuration of the bridge forwarder 234, filter 237, and virtual interface converter 236 corresponding to the second interface circuit 232₂ shown in FIG. 4, which corresponds to that shown in FIG. 5.

The circuit shown in FIG. 6 corresponds to the second EPON 205₂ shown in FIG. 3. Additionally, the subscript of the reference character indicates the virtual or multicast Ethernet® number, and is different from that of FIG. 5. Except for subscripts, like reference characters refer to corresponding portions in FIGS. 5 and 6, and the same description will not be repeated.

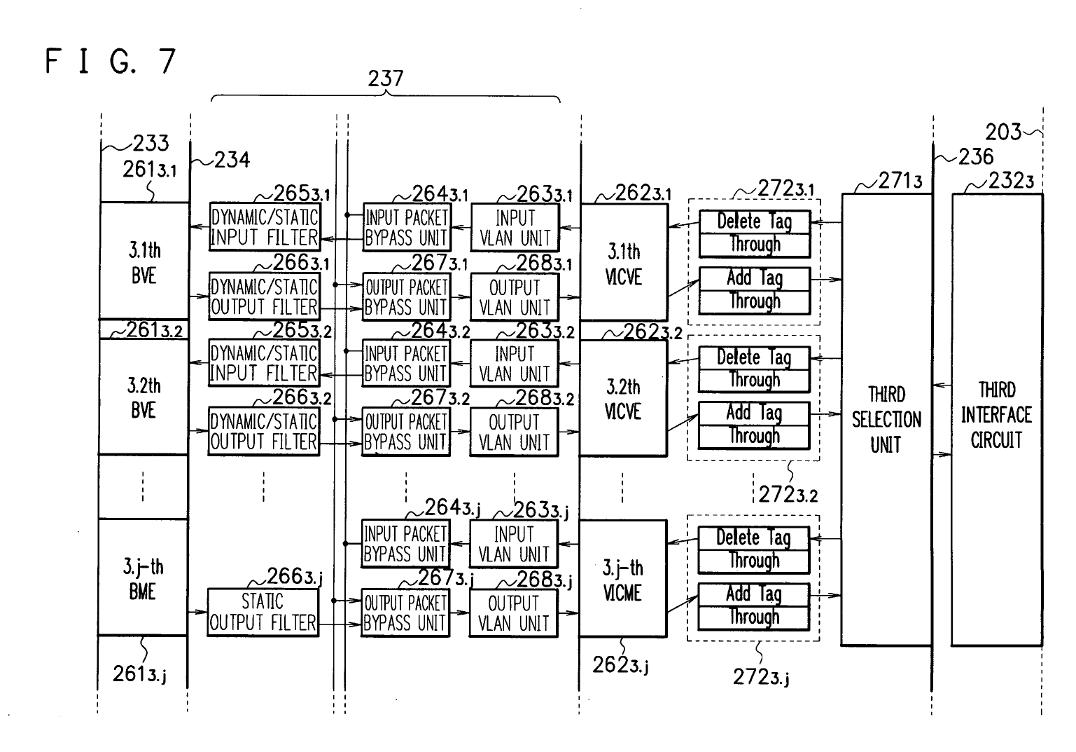

Next, referring to FIG. 7, a description will be given of the configuration of the bridge forwarder 234, filter 237, and virtual interface converter 236 corresponding to the third interface circuit 232₃ shown in FIG. 4. FIG. 7 shows the configuration of the bridge forwarder 234, filter 237, and virtual interface converter 236 corresponding to the third interface circuit 232₃ shown in FIG. 4, which corresponds to that shown in FIG. 5.

The circuit shown in FIG. 7 corresponds to the third port P₃ shown in FIG. 3. Additionally, the subscript of the reference character indicates the virtual or multicast Ethernet® number, and is different from that of FIG. 5. Except for subscripts, like reference characters refer to corresponding portions in FIGS. 5 and 7, and the same description will not be repeated.

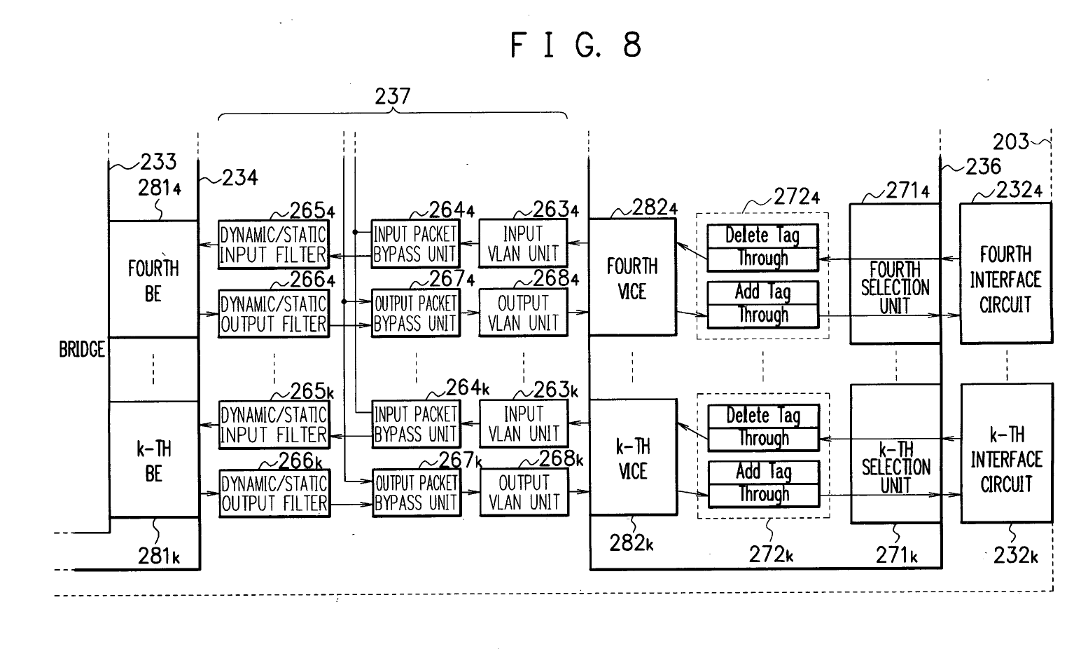

Next, referring to FIG. 8, a description will be given of the configuration of the bridge forwarder 234, filter 237, and virtual interface converter 236 corresponding to the fourth to k-th interface circuits 232₄ to 232ₖ shown in FIG. 4. FIG. 7 shows the configuration of the bridge forwarder 234, filter 237, and virtual interface converter 236 corresponding to the fourth to k-th ports P₄ to Pₖ shown in FIG. 3, which corresponds to that shown in FIG. 5.

As shown in FIG. 8, in the bridge 233, fourth to k-th bridge side Ethernet® units (BE) 281₄ to 281ₖ are arranged in one to one correspondence with the respective communication terminals 226₁ to 226ₖ₋₃ shown in FIG. 3. Besides, in the virtual interface converter 236, fourth to k-th virtual interface converter side Ethernet® units (VICE) 282₄ to 282ₖ, and fourth to k-th selection units 271₄ to 271ₖ are arranged in one to one correspondence with the respective communication terminals 226₁ to 226ₖ₋₃ shown in FIG. 3. Between the fourth to k-th virtual interface converter side Ethernet® units (VICE) 282₄ to 282ₖ and the fourth to k-th selection units 271₄ to 271ₖ, tag processing units 272₄ to 272ₖ are provided.

In the circuit shown in FIG. 8, as shown in FIG. 3, the fourth to k-th ports P₄ to Pₖ are connected in one to one correspondence with the communication terminals 226₁ to 226ₖ₋₃. Although the virtual interface converter 236 is provided with the tag processing units 272₄ to 272ₖ and fourth to k-th interface circuits 232₄ to 232ₖ similarly to the circuits corresponding to the other ports, packets may pass through these circuits without being attached with a VLAN tag.

In a conventional apparatus different from that of the present invention, even if the bridge forwarder 234 shown in FIG. 4 can distinguish, for example, the first interface circuit 232₁ from the second to k-th interface circuits 232₂ to 232ₖ, it cannot perform finer identification with respect to each of the ONUs 209₁₁ to 209₁ₘ and 209₂₁ to 209₂ₘ, and the plurality of communication terminals 224₁ to 224ⱼ connected to the switch 223 shown in FIG. 3. In this embodiment, a VLAN tag is used to solve that problem. The virtual interface converter 236 of this embodiment converts the VLAN tag into a virtual Ethernet® number as a virtual interface number, and performs processing corresponding to each of the ONUs 209₁₁ to 209₁ₘ, 209₂₁ to 209₂ₘ, and the plurality of communication terminals 224₁ to 224ⱼ connected to the switch 223. The virtual interface table 238 shown in FIG. 4 is used for this conversion.

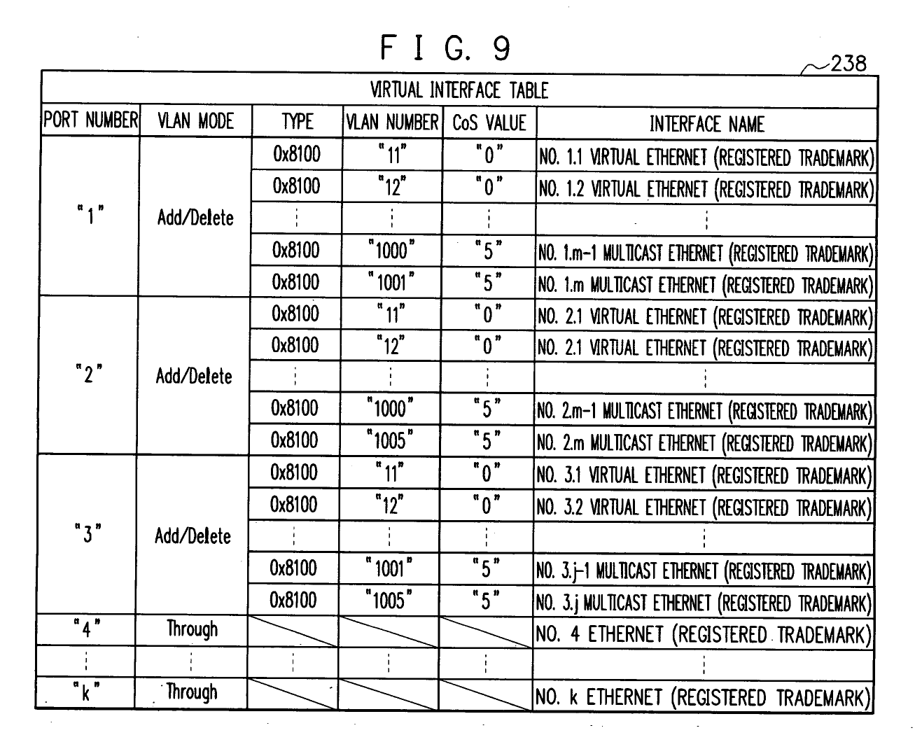

In the following, the configuration of the virtual interface table 238 shown in FIG. 4 will be described referring to FIG. 9. FIG. 9 shows the configuration of the virtual interface table 238 shown in FIG. 4. An administrator of the packet communication system 200 creates the virtual interface table 238, and updates it manually if necessary.

As shown in FIG. 9, the virtual interface table 238 contains such items as “port number” indicating a physical port corresponding to one of numbers “1” to “k” of the first to k-th interface circuits 232₁ to 232ₖ shown in FIG. 4, “VLAN mode” indicating “Add/Delete” mode or “Through” mode, “type” for identifying the type of a packet, “VLAN number” indicating a network number as a VLAN, “CoS (Class of Service) value”, and an “interface name”.

Here, the “Add/Delete” in the VLAN mode means the addition or deletion of a VLAN tag. Besides, “Through” means to pass through a packet without any processing for a VLAN tag. In the case of the port number between “4” and “k”, a subscriber loop can be remote-controlled without using a VLAN tag, and VLAN mode is “Through”. On the other hand, in the case of the port number between “1” to “3”, the VLAN mode is “Add/Delete”. The type indicates a TPID (Tag Protocol Identifier), and when the type of a packet is Ethernet®, it is set to “0x8100”. A user can set or change the value indicating the type.

Incidentally, as can be seen in the virtual interface table 238 of FIG. 9, two types of VLAN numbers, two-digit number and four-digit number, are used in this embodiment to differentiate the virtual Ethernet® and multicast Ethernet®.

For example, in the conventional technology, as to a packet whose port number is “1”, even if it can be recognized that the first interface circuit 232₁ shown in FIG. 4 corresponds to the packet, it is not possible to have information more than this, such as a path through which it arrives at the first interface circuit 232₁. However, in this embodiment, a packet with a VLAN tag corresponding to each of the ONUs 209₁₁ to 209₁ₘ shown in FIG. 3 arrives at the virtual interface converter 236 shown in FIG. 4. With respect to packets having the port number “1”, a packet with the VLAN number used for interface identification “11” may be associated with the interface name of an internal bridge interface “1.1”. Similarly, a packet with the VLAN number “12” may be associated with the interface name of an internal bridge interface “1.2”.

Thus, in this embodiment, a VLAN number input to one physical port (a port whose port number is “1”) is associated with an interface name using the virtual interface table 238 shown in FIG. 9. Thereby, the first selection unit 271₁ can classify packets each having a VLAN tag corresponding to each of the ONUs 209₁₁ to 209₁ₘ shown in FIG. 3 into packets corresponding to the respective tag processing units 272_{1.1} to 272_{1.m}.

For example, it is assumed that a packet attached with a VLAN tag with the VLAN number “11” is sent from the ONU 209₁₁ shown in FIG. 3 to the first selection unit 271₁ of the virtual interface converter 236 shown in FIG. 5. In this case, the packet is associated with the interface name “1.1” in the first selection unit 271₁, and sent to the tag processing unit 272_{1.1}. Since the VLAN mode indicated by the virtual interface table 238 is “Add/Delete”, the tag processing unit 272_{1.1} removes the VLAN tag added to the head of the packet. Then, the packet is input to the input VLAN unit 263_{1.1} from the 1.1th virtual interface converter side virtual Ethernet® unit 262_{1.1}, and sent to the input packet bypass unit 264_{1.1}.

When the destination of the received packet is a VLAN belonging to the first EPON 205₁ which corresponds to the source of the packet, the input packet bypass unit 264_{1.1} returns the packet to the corresponding input packet bypass unit 264_{1.x}. Here, x indicates the X-th communication terminal 210₁ₓ as the destination. In this case, that packet is sent to the X-th communication terminal 210₁ₓ through the ONU 209_{1X} belonging to the first EPON 205₁.

Otherwise, i.e., when the destination is not a VLAN belonging to the first EPON 205₁, the packet received by the input packet bypass unit 264_{1.1} is sent to the dynamic/static output filter 265_{1.1} and undergoes dynamic filtering and static filtering. Then, the packet is input to the 1.1th bridge side virtual Ethernet® unit 261_{1.1} of the bridge forwarder 234.

When a packet sent through the first port P₁ shown in FIG. 3 is transmitted to its destination through any of the second to k-th ports P₂ to Pₖ of the subscriber loop remote control apparatus 203, the bridge 233 returns the packet therein.

In cases other than this, i.e., when a packet sent through the first port P₁ shown in FIG. 3 is not transmitted to its destination through any of the second to k-th ports P₂ to Pₖ of the subscriber loop remote control apparatus 203, the bridge 233 sends the packet to the static output filter 245 from the 0th ET unit 230 shown in FIG. 4 so that the packet is subject to filtering on predetermined filter conditions. Then, the packet passing through the static output filter 245 is sent to the output VLAN unit 247 through the output packet bypass unit 246. Besides, the IP host unit 235 sends an IGMP or a DHCP message to the output packet bypass unit 246. These packets are sent to the output VLAN unit 247, and transmitted in the uplink direction through the 0th interface circuit 231 and 0th port P₀ therefrom. In addition, the output VLAN unit 247 performs the processing for the conventional VLAN tagging defined by IEEE (The Institute of Electrical and Electronics Engineers, Inc.) 802.1Q.

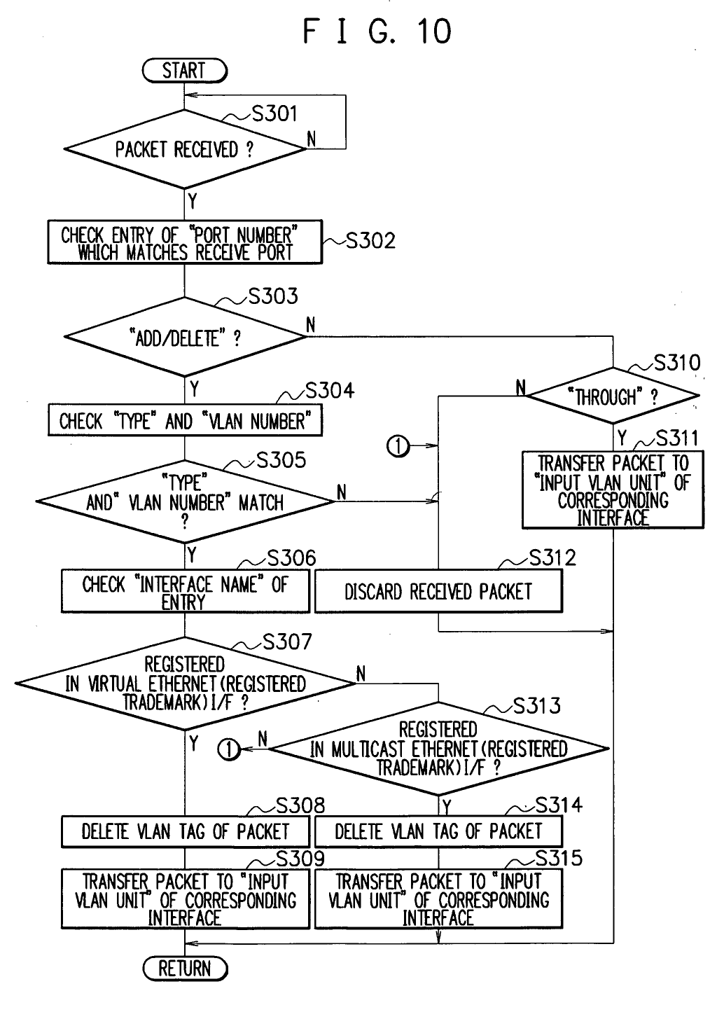

Next, control operation of the virtual interface converter 236 for transmitting a packet in the uplink direction will be described referring to FIG. 10. FIG. 10 is a flowchart showing the control operation of the virtual interface converter 236 of this embodiment.

Incidentally, although not shown, the virtual interface converter 236 in the subscriber loop remote control apparatus 203 comprises a CPU (Central Processing Unit), and a storage for storing a program executed by the CPU. It is obvious that part or all of control by software using such a program may be performed by hardware.

First, the subscriber loop remote control apparatus 203 waits until a packet is received from the first to k-th ports P₁ to Pₖ shown in FIG. 3 (step S301). When a packet is received (step S301: Y), the virtual interface converter 236 refers to the virtual interface table 238 shown in FIG. 9 to check the entry of a port number which matches that of a receive port (step S302). When the virtual interface table 238 indicates “Add/Delete” as VLAN mode (step S303: Y), the virtual interface converter 236 checks the corresponding type and VLAN number in the virtual interface table 238 (step S304). The above process is performed when the port number of the receive port is between “1” to “3”.

Next, when the type and VLAN number match those of the packet (step S305: Y), the virtual interface converter 236 checks the interface name (step S306). If the interface name is registered as a virtual Ethernet® interface (I/F) (step S307: Y), the tag processing unit 272 deletes the VLAN tag of the packet (step S308). Then, a frame (VLAN packet) is transmitted to the input VLAN unit of the corresponding virtual Ethernet® interface (step S309).

On the other hand, when the virtual interface table 238 does not indicate “Add/Delete” as VLAN mode (step S303: N), it is determined whether the table indicates “Through” as another mode (step S310). When the virtual interface table 238 indicates “Through” as VLAN mode (step S310: Y), the packet is transmitted to the input VLAN unit 263 of the corresponding Ethernet® interface without any processing such as the deletion of the VLAN tag (step S311). The above process is performed when packets are received from the fourth to k-th ports P₄ to Pₖ shown in FIG. 3.

In addition, when the virtual interface table 238 does not indicate “Through” as VLAN mode (step S310: N), i.e., the VLAN mode is neither “Add/Delete” nor “Through”, it means that a packet which is not assumed in the virtual interface table 238 shown in FIG. 9 has arrived. In this case, the received packet is discarded as an error occurs (step S312).

Besides, when the interface name is not registered as a virtual Ethernet® interface (1/F) (step S307: N), it is determined whether the interface name is registered as a multicast Ethernet® interface (step S313). If the interface name is registered as a multicast Ethernet® interface (step S313: Y), the tag processing unit 272 deletes the VLAN tag of the packet (step S314). Then, the packet is transmitted to the input VLAN unit of the corresponding multicast Ethernet® interface (step S315). On the other hand, if the interface name is not registered as a multicast Ethernet® interface (step S313: N), the received packet is discarded (step S312).

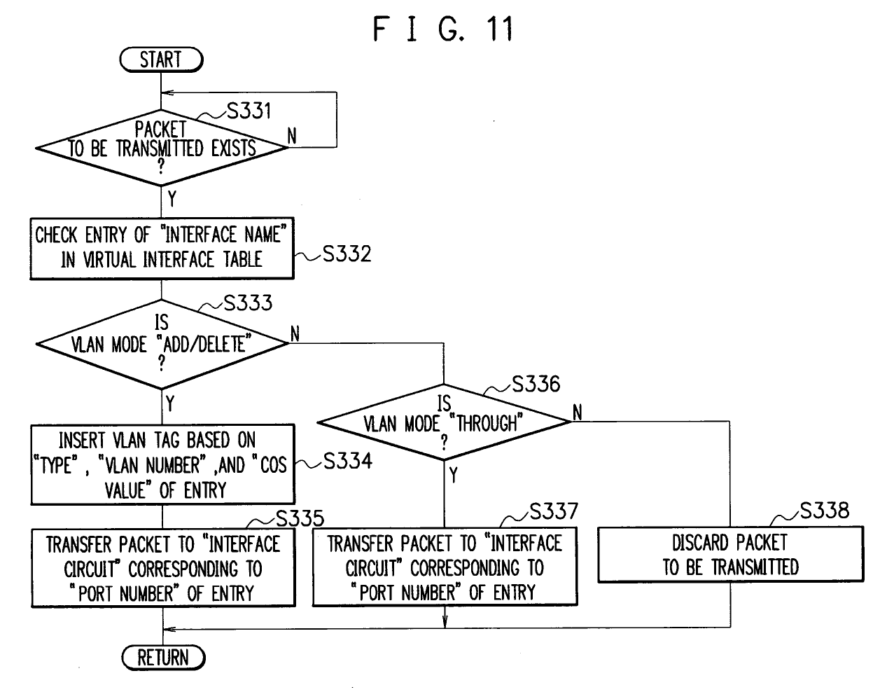

Next, the control operation of the virtual interface converter 236 for transmitting a packet in the downlink direction will be described referring to FIG. 11. FIG. 11 is a flowchart showing the control operation of the virtual interface converter 236 of this embodiment.

First, when having determined that there is a packet to be transmitted from one of the first to k-th ports P₁ to Pₖ shown in FIG. 3 (step S331: Y), the virtual interface converter 236 refers to the virtual interface table 238 shown in FIG. 9 to check the entry of a corresponding interface name (step S332). Then, for example, as in the case of the port number “1”, when the VLAN mode of the entry is “Add/Delete” (step S333: Y), a VLAN tag is inserted in the packet based on the type, VLAN number, and COS value of the entry (step S334). Here, the COS value is used for transmission in the downlink direction. Next, the selection unit 271 sends the packet to the interface circuit 232 corresponding to the port number of the entry (step S335). In this case, for example, the packet is transmitted to the OLT 204 from the first interface circuit 232₁ whose port number is “1”.

When the VLAN mode of the entry is not “Add/Delete” (step S333: N), it is determined whether the VLAN mode of the entry is “Through” (step S336). If the VLAN mode of the entry is “Through” (step S336: Y), the packet is transmitted to an interface circuit corresponding to the port number of the entry (step S337).

Besides, when the VLAN mode of the entry is not “Add/Delete” (step S333: N), and also is not “Through” (step S336: N) or the packet does not contain the description of the VLAN mode, the packet to be transmitted is discarded as in step S312 shown in FIG. 10 (step S338).

As described above, when a packet with a VLAN tag arrives from the ONUs 209₁₁ to 209₁ₘ, ONUs 209₂₁ to 209₂ₘ, and switch 223, the virtual interface converter 236 of the subscriber loop remote control apparatus 203 of this embodiment converts the VLAN tag added to the packet into a virtual interface number when associating the packet with an interface of the apparatus 203. Also, the subscriber loop remote control apparatus 203 discards the VLAN tag which becomes unnecessary. On the other hand, when a packet is transmitted to the ONUs 209₁₁ to 209₁ₘ, ONUs 209₂₁ to 209₂ₘ, and switch 223, a VLAN tag corresponding to the interface number is attached to the packet before transmission.

Additionally, the tag processing unit 272 adds a VLAN tag to a packet transmitted to a communication cable through any of the first to third interface circuits 232₁ to 232₃ from the virtual interface converter 236. Hence, the OLT 204 or ONUs 209₁₁ to 209₁ₘ, ONUs 209₂₁ to 209₂ₘ, and switch 223 shown in FIG. 3 can identify the communication terminals 210₁₁ to 210₁ₘ, communication terminals 210₂₁ to 210₂ₘ, and communication terminals 224₁ to 224ⱼ using the VLAN tag. Consequently, the OLT 204 or ONU 209₁₁ to 209₁ₘ, ONU 209₂₁ to 209₂ₘ, and switch 223 can perform filtering of the transmitted packet.

The ONUs 209₁₁ to 209₁ₘ, ONUs 209₂₁ to 209₂ₘ, and switch 223 can add a VLAN tag to packets transmitted from the communication terminals 210₁₁ to 210₁ₘ, communication terminals 210₂₁ to 210₂ₘ, and communication terminals 224₁ to 224ⱼ before transmitting the packet to the subscriber loop remote control apparatus 203 via the OLT 204. Therefore, the subscriber loop remote control apparatus 203 can perform desired processing, such as filtering, for a packet using the dynamic/static input filter 265 in the apparatus 203 with respect to each of the ONUs 209₁₁ to 209₁ₘ, ONU 209₂₁ to 209₂ₘ, or communication terminals 224₁ to 224ⱼ, connected in the switch 223.

When a certain control data transmitter is provided between the subscriber loop remote control apparatus 203 and OLT 204, if the OLT 204 checks the VLAN tag of each packet passing through the transmitter, desired processing, such as filtering, can be performed for the packet in both the uplink direction and downlink direction with respect to each of the ONU 209₁₁ to 209₁ₘ or ONU 209₂₁ to 209₂ₘ.

In this embodiment, when communication is performed between the communication terminals 210₁₁ to 210₁ₘ shown in FIG. 3, packets are returned by the subscriber loop remote control apparatus 203 without through the router 202. That is, in the conventional system, the router 202 individually checks IP addresses of the communication terminals 210₁₁ to 210₁ₘ and the like to return packets. For example, when the communication terminal 210₁₁ sends a packet to another communication terminal 210₁₂, the router 202 checks the destination and returns the packet to the communication terminal 210₁₂. Since an IP address of each communication terminal 210 changes in the DHCP packet communication in which IP addresses are dynamically assigned, the communication is preferable in respect of security. However, the packet communication has a problem in throughput because the router 202 has to always prepare a table reflecting IP addresses of the communication terminals 210.

Additionally, in this embodiment, packets may be returned by the forwarding function of the bridge 233. For example, in the conventional system, a packet passing through the 1.1th virtual interface converter side virtual Ethernet® unit (1.1th VICVE) 262_{1.1} shown in FIG. 5, and a packet passing through the 1.2th virtual interface converter side virtual multicast Ethernet® unit (1.2th VICVE) 262_{1.2} pass the bridge 233 as packets with the same VLAN tags corresponding to the first port P₁ without interacting with each other therein. On the other hand, in this embodiment, a VLAN tag attached to a packet is replaced by a virtual identifier as a virtual Ethernet® number individually corresponding to each of the ONUs 209₁₁ to 209₁ₘ, the bridge 233 can recognize them as different interfaces. Accordingly, in this embodiment, an original function of the bridge 233 is utilized and switching can be performed between the virtual ports with respect to each of ONUs 209₁₁ 209₁ₘ. As a result, for example, when the communication terminal 210₁₁ sends a packet to another communication terminal 210₁₂, the bridge 233 can return the packet therein.

For this reason, it is not necessary to use the special router 202 having a return function as in the conventional system, and a system can be economically implemented. In addition, since the router 202 need not perform the update process to acquire the current IP address of each communication terminal 210, it is also possible to reduce traffic between the router 202 and bridge 233.

In the embodiment described above, although VLAN numbers are not assigned with respect to the fourth to k-th ports P₄ to Pₖ, connected in one to one correspondence to communication terminals, among the first to k-th ports P₁ to Pₖ for the connecting the subscriber loop remote control apparatus 203 to optical fibers, processing may not be performed in such a manner.

Further, although in the packet communication system shown in FIG. 3, the ONU 209 is connected in one to one correspondence with the communication terminal 210, the ONU 209 may be connected in one-to-many correspondence with the communication terminals 210. In this case, as in the switch 223 mentioned above, each packet is transmitted in the uplink direction with a VLAN tag so that a plurality of communication terminals connected to the ONU 209 can be individually identified.

Still further, a series of the processes performed in the subscriber loop remote control apparatus 203 of the embodiment may be implemented by a computer program. In such a case, the program may be stored in a recording medium such as an optical storage medium, a magnetic storage medium, a magneto-optical storage medium, or a semiconductor, and the subscriber loop remote control apparatus 203 may perform a series of the processes by reading the program with the information processor. Or, the subscriber loop remote control apparatus 203 may perform a series of the processes by reading the program with the information processor from an external device connected through a predetermined network.

While the present invention has been described with reference to the particular illustrative embodiment, it is not to be restricted by the embodiment but only by the appended claims. It is to be appreciated that those skilled in the art can change or modify the embodiment without departing from the scope and spirit of the present invention.

What is claimed is:

1. A subscriber loop remote control apparatus, comprising:
an association table for associating a subscriber premises terminal identifier individually assigned to a subscriber premises terminal connected through a communication cable to a port assigned to every packet of each group which constitutes a VLAN with the port number of the port to store and manage them;
a packet receiver for receiving a VLAN packet with a subscriber premises terminal identifier and a port number;
an association table checker for checking the association table based on the port number and the subscriber premises terminal identifier attached to the VLAN packet received by the packet receiver, and determining whether or not the subscriber premises terminal identifier attached to the VLAN packet matches any of those in the association table; and
a packet return unit for returning, when the association table checker has determined that the subscriber premises terminal identifier attached to the VLAN packet matches one of those in the association table, the VLAN packet to the subscriber premises terminal with the subscriber premises terminal identifier.

2. The subscriber loop remote control apparatus according to claim 1, wherein the association table stores and manages processing instruction data indicating the addition or deletion of the subscriber premises terminal identifier to/from the VLAN packet.

3. The subscriber loop remote control apparatus according to claim 1, further comprising:
a subscriber premises terminal identifier adder for adding the subscriber premises terminal identifier corresponding to the subscriber premises terminal which transmits the VLAN packet to the VLAN packet using the association table; and
a packet transmitter for transmitting the VLAN packet to which the subscriber premises terminal identifier is added by the subscriber premises terminal identifier adder from a port corresponding to the port number attached to the VLAN packet.

4. The subscriber loop remote control apparatus according to claim 1, further comprising a VLAN packet uplink side transmitter for deleting the subscriber premises terminal identifier from the VLAN packet when the association table checker has determined that the subscriber premises terminal identifier attached to the VLAN packet does not match any of those in the association table to transmit the VLAN packet to the uplink side.

5. The subscriber loop remote control apparatus according to claim 2, wherein:
the processing instruction data includes data indicating to pass through the VLAN packet without the addition or deletion of the subscriber premises terminal identifier to/from the VLAN packet; and
the packet receiver passes through the VLAN packet when receiving the VLAN packet attached with no the subscriber premises terminal identifier.

6. The subscriber loop remote control apparatus according to claim 1, wherein:
the subscriber premises terminal is an ONU; and
the association table associates the port number in one-to-many correspondence with subscriber premises terminal identifiers individually assigned to the ONUs to store and manage them.

7. The subscriber loop remote control apparatus according to claim 1, wherein:
the subscriber premises terminal is a layer 2 switch; and
the association table associates the port number in one-to-many correspondence with subscriber premises terminal identifiers corresponding to respective connection ports of the switch.

8. A subscriber loop remote control method applied to a subscriber loop remote control apparatus including an association table for associating a subscriber premises terminal identifier individually assigned to a subscriber premises terminal connected through a communication cable to a port assigned to every packet of each group which constitutes a VLAN with the port number of the port to store and manage them, the method comprising the steps of:
receiving a VLAN packet with a subscriber premises terminal identifier and a port number;
checking the association table based on the port number and the subscriber premises terminal identifier attached to the received VLAN packet, and determining whether or not the subscriber premises terminal identifier attached to the VLAN packet matches any of those in the association table; and
returning, when the subscriber premises terminal identifier attached to the VLAN packet matches one of those in the association table, the VLAN packet to the subscriber premises terminal with the subscriber premises terminal identifier.

9. The subscriber loop remote control method according to claim 8, further comprising the steps of:
adding the subscriber premises terminal identifier corresponding to the subscriber premises terminal which transmits the VLAN packet to the VLAN packet using the association table; and
transmitting the VLAN packet attached with the subscriber premises terminal identifier from a port corresponding to the port number attached to the VLAN packet.

10. The subscriber loop remote control method according to claim 8, further comprising the step of deleting the subscriber premises terminal identifier from the VLAN packet when the subscriber premises terminal identifier attached to the VLAN packet does not match any of those in the association table to transmit the VLAN packet to the uplink side.

11. The subscriber loop remote control method according to claim 8, wherein:
the subscriber premises terminal is an ONU; and
the association table associates the port number in one-to-many correspondence with subscriber premises terminal identifiers individually assigned to the ONUs.

12. The subscriber loop remote control method according to claim 8, wherein:
the subscriber premises terminal is a layer 2 switch; and
the association table associates the port number in one-to-many correspondence with subscriber premises terminal identifiers corresponding to respective connection ports of the switch.

13. A subscriber loop remote control program for a subscriber loop remote control apparatus including an association table for associating a subscriber premises terminal identifier individually assigned to a subscriber premises terminal connected through a communication cable to a port assigned to every packet of each group which constitutes a VLAN with the port number of the port to store and manage them, the program causing the subscriber loop remote control apparatus to perform the steps of
receiving a VLAN packet with a subscriber premises terminal identifier and a port number;
checking the association table based on the port number and the subscriber premises terminal identifier attached to the received VLAN packet, and determining whether or not the subscriber premises terminal identifier attached to the VLAN packet matches any of those in the association table; and
returning, when the subscriber premises terminal identifier attached to the VLAN packet matches one of those in the association table, the VLAN packet to the subscriber premises terminal with the subscriber premises terminal identifier.

14. The subscriber loop remote control program according to claim 13, further causing the subscriber loop remote control apparatus to perform the steps of
adding the subscriber premises terminal identifier corresponding to the subscriber premises terminal which transmits the VLAN packet to the VLAN packet using the association table; and
transmitting the VLAN packet attached with the subscriber premises terminal identifier from a port corresponding to the port number attached to the VLAN packet.

15. The subscriber loop remote control program according to claim 13, further causing the subscriber loop remote control apparatus to perform the step of deleting the subscriber premises terminal identifier from the VLAN packet when the subscriber premises terminal identifier attached to the VLAN packet does not match any of those in the association table to transmit the VLAN packet to the uplink side.

16. The subscriber loop remote control program according to claim 13, wherein:
the subscriber premises terminal is an ONU; and
the association table associates the port number in one-to-many correspondence with subscriber premises terminal identifiers individually assigned to the ONUs.

17. The subscriber loop remote control program according to claim 13, wherein:
the subscriber premises terminal is a layer 2 switch; and
the association table associates the port number in one-to-many correspondence with subscriber premises terminal identifiers corresponding to respective connection ports of the switch.
